(19) United States
(12) Patent Application Publication
(10) Pub. No.: US 2015/0244969 A1
(43) Pub. Date: Aug. 27, 2015

(54) SYSTEM AND METHOD FOR RECORDING AND DISTRIBUTING VIDEO

(71) Applicant: KBA2, Inc., San Francisco, CA (US)

(72) Inventors: Jon B. Fisher, Tiburon, CA (US); Austin A. Markus, San Francisco, CA (US); Richard G. Smith, Lynwood, WA (US); Steven L. Harris, Perris, CA (US); James J. Kovach, San Rafael, CA (US)

(21) Appl. No.: 14/705,503

(22) Filed: May 6, 2015

Related U.S. Application Data
(60) Provisional application No. 60/003,366, filed on Sep. 7, 1995.
(60) Provisional application No. 62/060,514, filed on Oct. 6, 2014.

(51) Int. Cl. H04N 5/77

(52) U.S. Cl. CPC H04N 5/772; H04N 2101/00

(57) ABSTRACT

The various embodiments of the present invention relate to a system and method for gathering and analyzing data from a plurality of users at a specific event or a location with recording devices, which is executed real-time, wherein the plurality of users are aiming their image capture devices at a specific object at the event or the location, and subsequently creating a line of sight to an object of interest, thereby forming a cluster density of plurality of users, and sharing all the intersecting videos or metadata with the users in the same formed cluster. The plurality of image users are communicated from the plurality of image-capture devices to a remote server for subsequent statistical analysis of the proportionate amount of users focusing their devices on each target object at the specific event or the location.

### CROSS REFERENCE TO RELATED APPLICATIONS

This application claims the benefit of U.S. Provisional Application No. 60/003,366, filed May 27, 2014 and No. 62/060,514 filed Oct. 6, 2014, the disclosure of each of which is expressly incorporated herein by reference thereto.

### FIELD OF THE INVENTION

The embodiments of the present invention relate to a system and method for recording and distributing video. More particularly, the invention relates to a mobile recording and communication system and a method using the same. Thus the embodiments of the present invention relate to a system and method for gathering and analyzing data generated by image capture devices and collected from device users aiming their image capture devices, and thereby creating a line of sight to an object of interest, for example through the process of obtaining photographs, videos or other digital images of a specific event or location.

### BACKGROUND OF THE INVENTION

With the rapid growth in technologies in the 21^{st} century, that exclusively pertain to search of metadata feeds in the form of videos/text/images or any other format, there is an increasing need in order to provide, or to make available metadata feeds, that are relevant in terms of content, timing, length, geography, mandate, context, and also of interest to an entity including but not limited to a broadcaster, event manager, advertiser, and viewer.

Some efforts have been put forth in the domain of real-time metadata analysis in order to derive meaningful feedback for future actions. For example, crowd optic, and crowd cluster formation occurs when two or more observers focus their image capture devices at the same object of interest, which is a maker of crowd-driven mobile solutions for enterprises thus monitors crowd viewing, photo and video taking behavior, that is executed real-time as the event happens and recognizes clusters of phones in the crowd, that are focused on the same attraction, thereby giving indications of fan focus and momentum, as well as anomalous activity in the crowd.

Notwithstanding this, the prior art is still lacking the revolutionized use of crowd optic and systems and methods for determining crowd cluster formation or like platforms, that would define how viewers or other abovementioned stakeholders experienced, or are experiencing various metadata feeds such as video feeds from live sporting events or concerts.

Thus, in view of the above, given the lack of systems and methods in the area of utilizing crowd optic and determination of cluster formation, there is still an unmet need in the prior art for the development and implementation of such real-time systems and methods, that take into consideration all possible metadata feeds, attributes and parameters along with metrics that especially indicate how the stakeholders interact with the feeds.

### SUMMARY OF THE INVENTION

In accordance with one non-limiting embodiment of the present invention, a mobile recording and communication system for recording real-time at a specific event or location is described. The communication system comprises a recording device having a circuitry that captures video, a processor, a transient memory, and a non-transient memory, a software application resident on a mobile device, and a communication component comprising a server configured to provide associated services. The transient memory automatically and continuously stores buffered video from the recording device with a duration set by a user of the recording device. The video stored in the transient memory is permanently saved to the non-transient memory when the user selects to record using the recording device, and is permanently saved as a video with the duration set by the user. The recording device starts recording an event of interest when the user selects to record using the recording device and the recording devices produce a video of the event. The software application is executed by the processor and is configured to transmit the video over the wireless network to the server configured for providing associated services, which is both the buffered video and the video of the real-time event. The recording device, the software application, and the mobile device generate metadata for the buffered video and for the metadata of the video of the real-time event. The metadata comprises the position of the user, direction of focus of the user, speed of the user, or time and date of the video with the duration set by the user prior to the user selects to record and the video of the event. The recording device, the software application, and the mobile device further generate video assets based on the video with the duration set by the user prior to the user selecting to record, the video of the event, and the metadata for the video with the duration set by the user prior to the user selecting to record, and the metadata for the video of the event. The video assets comprise video highlights of a day, a thumbnail video of the user's experiences throughout a day, a compilation of all the metadata throughout a day, or a combination thereof. The mobile recording and communication system further comprise multiple recording devices, and the associated services comprise determining intersecting videos or metadata based on the videos or metadata received from the recording device and the multiple recording devices, thereby forming a cluster for the intersecting videos or metadata, and sharing all the similar intersecting video or metadata with the users in the formed cluster.

Embodiments of the present invention also provides a computer implemented method of identifying an observer's level of interest in an object at an event, wherein the method including the steps of providing a server comprising network communications components, identifying a plurality of observers at an event or location having active electronic devices capable of both capturing images and communicating metadata in the form of buffered and recorded video over the communication components, compiling the transmitted metadata and images generated by the electronic devices on the server, forming a cluster for the intersecting videos or metadata; and sharing all the intersecting video or metadata with the users in the formed cluster. The method further comprises a processor and associated memory that is configured to process the metadata to identify trends from cluster information in the metadata and configured to display the trends to a user of the system, and is further adapted to allow the user of the system to select specific buffered and recorded content associated with a particular trend to combine into a video asset capturing a visual event associated with the trend.

In accordance with yet another embodiment of the present invention, a mobile device is provided comprising a video recording component having circuitry that captures video, communications circuitry that is configured to provide personal voice or data communications over a wireless network, a processor, transient memory, and non-transient memory, and a software application resident on the mobile device that is executed by the processor and is configured to automatically store video from the video recording component in a circular buffer in the transient memory without the user selecting to record video using the video recording component, wherein the software application transmits, over the wireless network, video from the buffer to a server configured for providing an associated service when the user selects to record video using the video recording component.

It is a further embodiment of the present invention to provide a system comprising a server having communications components over which the server receives buffered and recorded video and individually associated metadata and comprises a processor and associated memory that is configured to process the metadata to identify trends from cluster information in the metadata and to display the trends to a user of the system and is further configured to allow the user of the system to select specific buffered and recorded content associated with a particular trend to combine into a video asset capturing a visual event associated with the trend.

In accordance with yet another embodiment of the present invention, a computer implemented method of identifying a user's level of interest in an object at an event or location is disclosed, wherein the method comprises automatically and continuously storing video from user's recording devices with a duration set by a user of the recording device without the user selecting to record using the recording device, saving the stored video in non-transient memory of a server when the user selects to record using the recording device, recording an event of interest when the user selects to record using the recording device and the recording devices produces a video of the event and transmitting over a wireless network to a server, both the video with the duration set by the user and the video of the event to the server wherein the server is configured for providing associated services for the event.

### BRIEF DESCRIPTION OF THE DRAWINGS

FIG. 1A demonstrates one embodiment of the mobile recording and communication system.

FIG. 1B depicts one embodiment of the steps performed as a flow diagram by the mobile recording and communication system to generate a cluster.

FIG. 2 is a diagram of a stadium demonstrating an event such as for example a football game.

FIG. 3 is a flow diagram of the general operation of an embodiment of the present invention.

### DETAILED DESCRIPTION OF THE INVENTIVE EMBODIMENTS

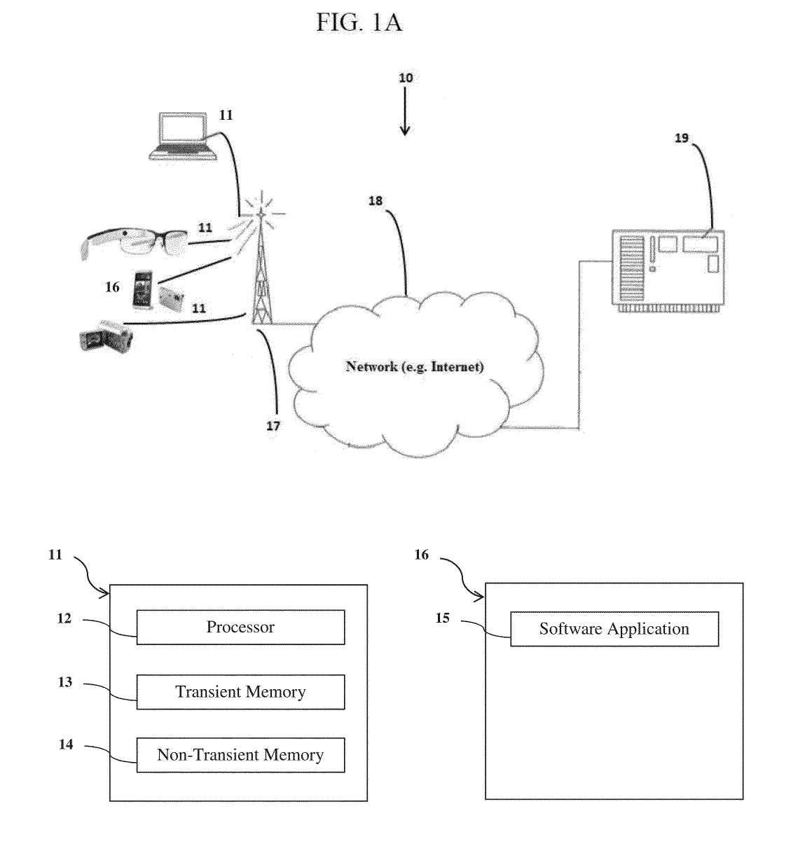

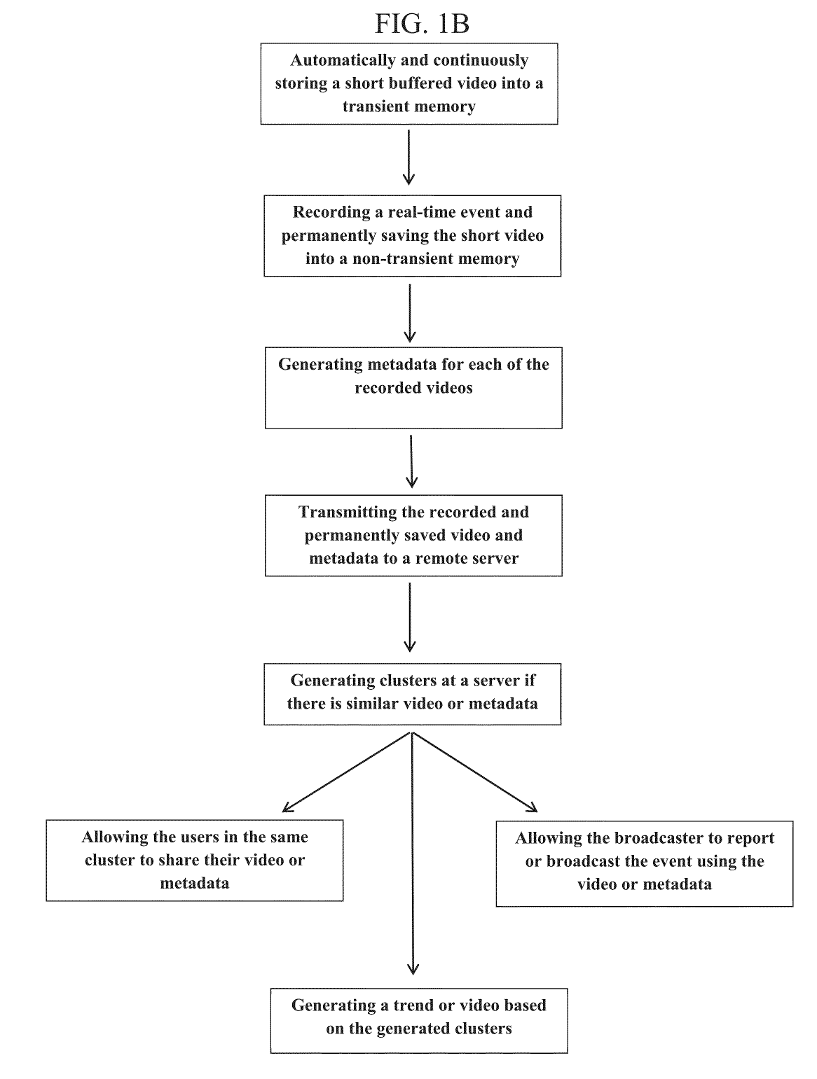

The detailed description of the preferred embodiment of the instant invention will now be provided with reference to FIGS. 1-3. However having said that it should be clearly understood that these figures are merely provided as exemplary in nature, and they should in no way serve to limit the scope of the invention, which is solely defined by the appended claims appearing herein-below.

Thus in accordance with an embodiment of the present invention, as demonstrated in FIG. 1A and FIG. 1B depicted as a flow diagram of the steps involved in the process of generating a cluster, the hardware of mobile recording and communication system 10 may comprise a recording device 11, electronics such as a processor 12, a transient memory 13, and a non-transient memory 14, a software application 15 resident on a mobile device 16, and a communication component 17 comprising a wireless network 18 and as a mobile device 16 such as but not limited to a server 19. A server 19 should be understood as being a running instance of an application (e.g. software) capable of accepting request from another device and accordingly give response to the other device.

The recording device 11 may be an eyewear apparatus, a camera, a camcorder, a smartphone, a tablet or other portable computer or any other type of handheld or portable electronic device that has circuitry capable of capturing video. The term “video” may encompass a series of visual images, or a combination of visual images and audio. The recording device 11 may be configured to record video in the non-transient memory 14, when a user of the recording device 11 selects to record video. The recording device 11 may also be configured to automatically and continuously store video from the recording device 11 in the transient memory 13 without the user selecting to record video (buffered video 20). The video stored in transient memory, which is the buffered video 20, is a video of events recorded prior to the user selecting to record video. This prior buffered video 20 may have a duration that is preset by the user in the recording device 11 or the software application 15. The duration may be several minutes or several seconds long. Since the transient memory 13 is temporary storage in nature, the buffered video 20 is constantly updated, so as to provide the most recent video prior to the video recorded when the user selects to record video (points to an object of interest and activates the camera's record button or option).

The recording device 11 may be further configured to simultaneously record video and permanently save the buffered video 20. As such, the user may have a video of what he or she recorded and a video prior to what he or she recorded or a combination thereof. Permanently saving or saving means that the video, which is stored as buffered video 20, is saved to the non-transient memory 14, or to another non-transient memory and is no longer in the transient memory 13.

The recording device 11 may also be configured to automatically record periodically, such as a time-frame of every hour, without the user actually having to select to record video. This provides periodic automatic updates of what the user is viewing.

Since the apparatus may also record periodically, the apparatus may provide up to three recordings. In another embodiment of the present invention, the apparatus may be set to record only the event of interest, only the small amount of content, only periodically or any combination based on only two recordings thereof. The buffer and the storage device may be embedded in the apparatus, or the electronic device on which the application is installed, or be situated at a location remote from the apparatus or the electronic device, such as a server 19 or the cloud. Placing the buffer and the storage device at a remote location may allow instant sharing with other users while the recording (or buffer content) is being transmitted to the remote location or immediately shared after saving at the remote location.

The amount of video to be recorded periodically may have the same duration as the buffered video 20, or a different duration set by the user. The periodic recording may also be the buffered video 20 itself by automatically saving that video into the non-transient memory 14. As such, the recording device 11 may provide up to three types of videos, namely, a video of what the user recorded, a video prior to what the user recorded, and a video recorded periodically before or after what the user recorded. While the description above suggests combining the video of what the user recorded and the video prior to what the user recorded and the periodic videos, these videos may be combined in any manner and any number or be recorded individually without combining. The recording device 11 may also be configured to record only one of these three types of videos.

As such, the metadata may be generated for each of the above three videos by the recording device 11 or the software application 15. The generated metadata for each video may be simultaneously recorded when the user selects to record video when the video is stored without the user selecting to record video is permanently saved, and when the recording device 11 records periodically. The metadata may include the position of the user, direction of focus of the user, the speed of the user, and time and date of the recording. Position information may include the longitude and latitude of the user. Direction of focus information may include compass heading data and the angle with respect to a reference point. The direction of focus information for the recording device 11 may be obtained by identifying the change in the direction of the facing of the device at a particular time and determining a new point of focus different from the initial point of focus as the focus changes to a new or different person, object, or location at a particular time. The direction of focus information for multiple recording devices 11 may also be obtained by collecting the direction of focus information from each device and determining if their information intersect or are similar. Based on the number of intersections, the popularity of the visual event they are watching may be determined. The number of intersections may also be used to identify and form clusters using techniques described in US Application Publication 2012/0233000 A1, the entire content of which is expressly incorporated herein by reference thereto. The level of interest, transitions in interest, trends, or commonalties may also be determined using those techniques. In order to identify trends from cluster information in the metadata and to display the trends to a user of the system, the user of the system can select specific buffered 20 and recorded content associated with a particular trend to combine into a video asset capturing a visual event associated with the trend. A visual event may be an event that is captured by a plurality of observers with a recording device 11 and can for example be a real-time concert or a sporting event or the like.

The metadata may be generated by the hardware in the apparatus and/or the electronic device on which the application has been installed. The generation of the metadata may collaborate with a Global Positional System (GPS) or a satellite to produce more accurate data.

Now the principle of cluster formation will be outlined and described in greater detail. Crowd cluster formation occurs when two or more observers focus their image capture devices at the same object of interest. Clusters are determined by using the algorithms to process the device attributes. Additional algorithms can be used to analyze a cluster so as to determine its significance, for example by its density. The clusters can be tagged to identify them as actionable items, for example social media, news material, advertising, or data, and then to distribute them using the tag(s). While an ideal situation is one, wherein the clusters are focused together on a precise point, this is often not the case as the size of the location may be large or the observers may focus on slightly different aspects or features of the location. For this reason, cluster density of associated points can be used to determine both a general location of interest, or the size of the location of interest. For example, if an actor is exiting a theater after a performance, a cluster of focused points would be formed on or very near the location of the actor, while if a large building was on fire, the cluster of points would be much greater as observers focus on various parts of the burning building.

In both examples, the density of the cluster would indicate the size of the location of interest, with the cluster surrounding the actor being much smaller than the cluster surrounding or focused on the burning building. As the observers interest evolves over time the direction of their lines of sight will shift to new locations in order to follow the particular object of interest, thereby causing a change in the angles between the lines of sight and the points of intersection. Such shifting may cause the size and density of a cluster to also change over that time.

If an observer's interest shifts to a new object of interest, their line of sight may change sufficiently that the point of intersection will no longer be associated with the original cluster. As more observers find new objects of interest, the original cluster will show a reduction in the number of intersecting lines of sight and a commensurate drop in density as the points of intersection exit the cluster's calculated area or maximum distance from other points of intersection associated with the original object. Similarly, as new observers focus on a particular object of interest, the number of intersecting lines of sight will grow causing the cluster density to increase, as would the significance attached to the cluster over that time period. These changes can be calculated through a combination of the triangulation calculations to determine the location of the intersection points, and the statistical analysis to determine the clusters and their densities and significance.

A data value relating to the popularity of the object of focus of the remote device can also be correlated with the location/direction/time data, wherein the popularity data can be a subjective value meant to differentiate the object of focus from the other targets present at an event base upon relative popularity, or an objective value determined from previous viewership, monetary compensation for appearing, or other measurable criteria.

The location, direction, popularity, and time can be used as a fingerprint to identify the object of focus and differentiate the object of focus from other potential targets present at the event at the same time. The triangulation calculations from the data transmitted from two or more remote image capture devices pointing towards a particular object of focus can generate a plurality of intersecting lines and a cluster of points where the lines intersect in essentially the same location. Different clusters of points resulting from different lines intersecting at spatially distinct locations at the same time can be used to differentiate the objects of focus from each other. Statistical analysis of the relative number of data points or the cluster size in the same area at the same time can be used to establish the relative popularity of each object of focus.

The cluster corresponds to actual objects of interest within the area where the observers are focused. The clusters, which is an area in space where two or more lines of sight intersect, can be analyzed by determining the arrangement and relative proximity of the points of intersection to each other and calculating a density of points in a given area, as the area encompassing the points of intersection change. The cluster density can also be defined as the points falling within an area a predetermined distance from a center point. The cluster can also be defined as a set of points, wherein each point is no further than a specific maximum distance from all other points forming the set, where the maximum distance may be predetermined or dynamically calculated based on the type of event. In this manner, points that are within a certain proximity of each other may be recognized as a cluster depending upon the type of object being observed.

A cluster of intersecting (or near intersecting) sightlines can represent a potential object or area of interest, and a cluster of users can be associated group of users focusing on the particular object. At least two sets of data can be obtained through the compilation and analysis, including the data related to the object of interest and the data related to the user group formed from the clusters, which may persist after the object of interest is no longer a focus of attention.

The clusters can be further analyzed to determine their size and the percentage of observers focusing on objects of the cluster. A cluster can have a set of characteristics including a number of points correlating with a known object of interest, a size (e.g., radius, diameter, unit area, spherical volume, etc.) location of its center, density (i.e., number of intersection points per unit area), percentage of observers or active devices transmitting data, etc.

The relevance of a particular cluster can be determined by the proportion of observers focusing on the specific objects of interest compared to the number of observers focusing on other objects of interest at an event. The relevance can also be based on the density of a cluster, such that a larger number of intersecting points in a smaller area is recognized as being more relevant than a similar number of points in a larger area or a lesser number of points in the smaller area.

The larger the number of observers at an event and the larger the sample size, the more accurate the determination of relevancy, and the ability to extrapolate the relevance and level of interest to other populations such as consumers to determine demographics. For example, crowd focus can show that a particular entertainer holds more interest for a given population that can then be used for product promotions to that population.

Each cluster created at an event represents a unique set of information that can be used to identify the objects of greatest interest, the peak period of the event based upon the greatest number of active devices focusing on the objects of an event at a particular time, and the shifting of interest from one object to another at a given time.

Once a cluster of points is determined, the cluster can be used to determine which observers were interested in the objects within the specified cluster, and alerting each of the observers focusing on an object forming the cluster of the other observers creating the cluster.

A cluster can also be tagged with information to further identify the object of interest or determine its relevance. The information can be provided by the observers transmitting images tagged with metadata about the object. Information can also be sent back to the electronic device identified as forming the specific cluster to alert the observers of others focused on the object of interest. The information can be sent from the server 19 to the electronic device and include the identification of the object or objects of interest being focused on, additional background information regarding the object or venue where the event is occurring, and/or advertisements for products that may be endorsed by the object of interest or for items that are related to the event. For example, a car manufacturer may send an advertisement for the brand of car being driven at a car race. Such additional information sent to the observer can then be incorporated into the metadata tags attached to the actual images sent from the electronic devices to the server system.

The formation of a cluster can be used to alert the observers or other parties of a shift in the observers interest or a new occurrence, and draw attention to such objects of interest by broadcasting the new cluster to those involved in the event. The alert can be used to direct other media towards the object(s) of interest. For example, television broadcasters can be alerted of a shift in attention and focus their cameras on new activity that is attracting the attention of the observers, and display highly relevant occurrences on larger general displays. As another example, a shift in attention from the stage or field at an event to the stands can be recognized as an anomaly and alert security to an occurrence, security risk, or crisis that may require a response. The anomaly is recognized based on a relevant amount of crowd focus on an unexpected location.

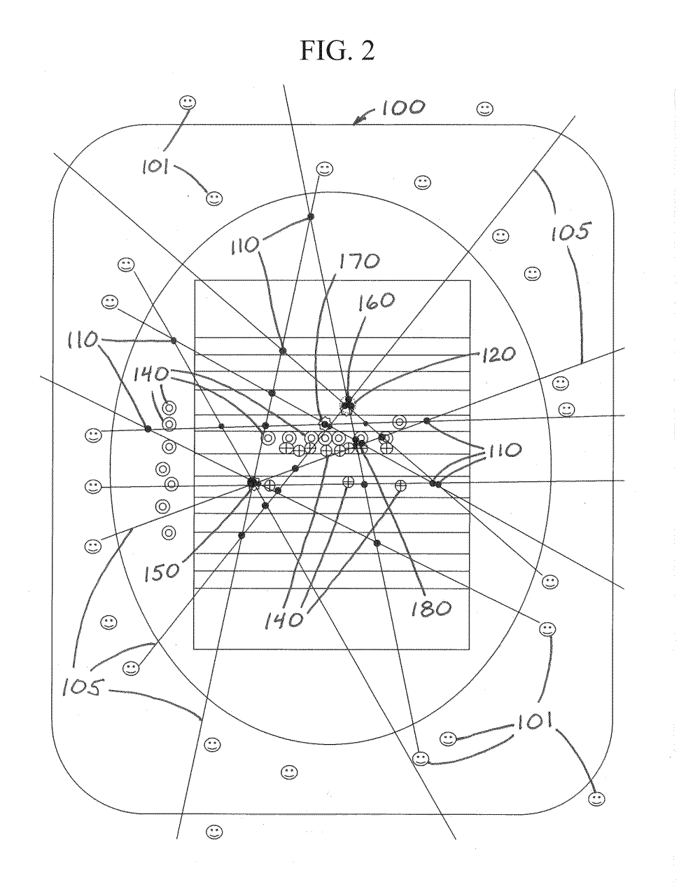

An example of a sporting event is illustrated in FIG. 2, where observers 101 are located both inside and outside a stadium 100. At various times during the game, observers 101 with remote electronic devices, such as smart phones, running a remote application are focused on different objects both on and off the field. Each of the remote electronic devices have specific GPS coordinates and are facing in a specific direction as determined for example by a compass heading. The attributes are unique for each electronic device, and can be communicated to a remote server 19 as a continuous stream of data reflecting the real time position and facing of the devices. The server or server system receives the continuous data feeds from each of the remote electronic devices and can compile the data in a data base for subsequent calculations and analysis using various algorithms. The object being focused on by an observer 101 can be determined by calculating a line of sight 105 propagating away from the observer's device, and determining which lines of sight emanating from other remote devices intersect the observer's line of sight 105. The points of intersection 110 can be calculated through triangulation. In this manner, multiple points of intersection 110 can be identified as indicated by black circles in FIG. 2. Once the points of intersection 110 have been determined clusters 120 can be identified which points of intersection are closely packed together compared to individual points randomly scattered about. For example, four lines intersect what would be a wide receiver 150 moving down field creating a particular cluster, whereas three lines intersect a running back 160 and two lines intersect the quarterback 170. An additional cluster of three intersecting lines occurs on the line of scrimmage 180, but that random arrangement of intersecting lines would be recognized to have a statistically lower density than the specific objects of interest. Identifying the most densely packed cluster that fall on the observer's line of sight would be considered to statistically be that observer's object of interest.

As players 140 moved about the field, the points of intersection 110 would shift with time as the play unfolds and different players engage in different actions. The system can follow both the movement of the players and the shifting of attention from one player or location to another by tracking the points of intersection and measuring the change in density of the clusters associated with the different player. For example, the audiences' attention would suddenly shift from the quarterback 170 to a wide receiver 150 once a pass is thrown. This would be indicated by a large increase in the number of intersecting lines occurring at the location of the wide receiver 150, and would be recognized as a large increase in the density and therefore relevance of that cluster.

By analyzing the density of the clusters, other parties can follow the audiences point of focus and use that to direct their own actions, such as focusing television cameras on the same player at the same time, or displaying additional information to the observers focused on that player, such as his name and statistics. Advertisements could also be sent back to the observers electronic devices. For example, if the running back endorses a particular brand of shoe, observers focused on the running back could receive an advertisement for that shoe during the time they are focused on that player.

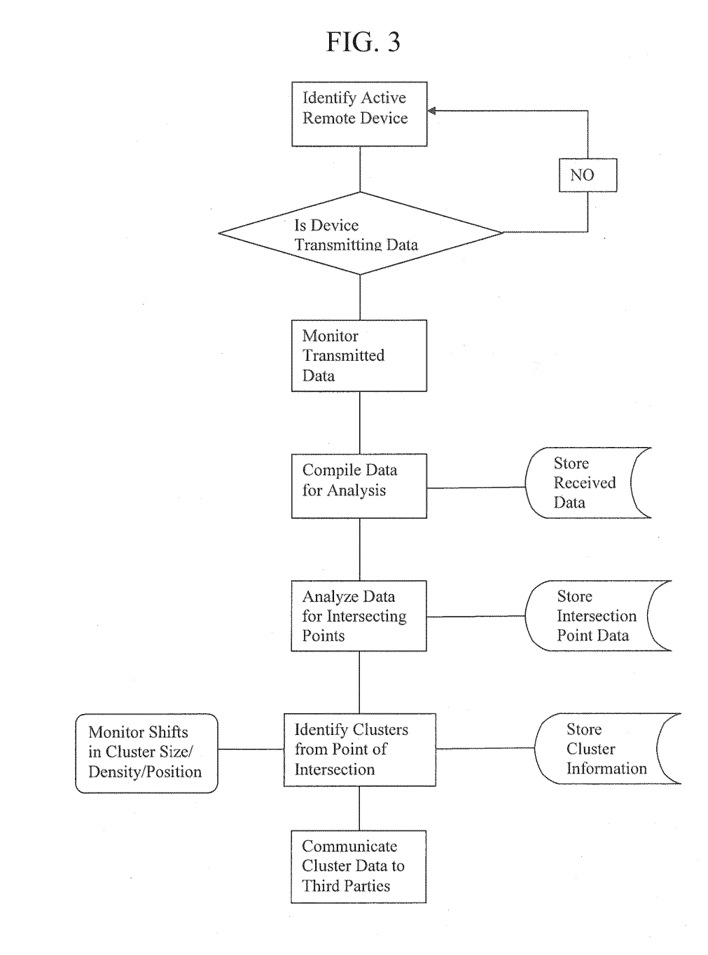

The general operation of an embodiment of the invention is shown in the flow chart of FIG. 3. The system identifies the one or more remote devices that are in communication with the computer system, which can both be a physical or virtual server 19, and determines whether the device is active (i.e., powered up and running the application) and transmitting data to the computer system. If the device is not transmitting data, for example if it was being used a phone, the system checks to see if other active devices are transmitting data. If the computer system detects an incoming stream of data, the computer monitors the data stream to determine if the data is sufficiently consistent to use for calculations. If the transmitted data values are erratic, the data is filtered out. If the data is consistent, the data is compiled by the computer system and stored for analysis. The application program analyzes the received data to identify points where lines of sight intersect. The points of intersection are stored by the computer for further analysis. The application program analyzes the points of intersection to identify clusters that would indicate objects of interest located where there are higher densities of points compared to the background. The information on the cluster(s) are stored on the computer system, where the information can include the cluster's location, density, what kind of occurrence or type of actual object the cluster represents, the ratio of intersecting points forming the cluster compared to the total number of intersecting points, a time stamp, etc., and is used to tag and identify the cluster. Since the clusters change over time as occurrences end and new events begin, or the objects of interest move about, or the level of interest in the object or occurrence changes, these changes can also be stored and monitored. The information tagging the cluster can be communicated to other parties that would be interested in the data. The parties could be parties that are tasked to monitor the formation and shifting of clusters, such as security or news agencies, or would make decisions based upon the information, such as broadcasters and advertisers.

In accordance with an embodiment of the present invention, the recording device 11 may be utilized to record an event of interest. Thus as described herein-above, the event of interest may be a sporting event, a concert, an emergency situation, or any event in which the user has interest. It may also be a spontaneous event that may arise in everyday life that is often times the subject of great social interest (e.g., viral videos).

Thus the different steps in creating the cluster is outlined in greater detail in FIG. 1B. A short buffered video 20 is automatically and continuously stored in a transient memory 13. Then a user records a real-time event and permanently saves the short video into a non-transient storage memory 14. Metadata is generated for each of the permanently recorded and saved videos and then transmitted to a remote server 19. According to above description, clusters are generated at a server 19, if there is similarity between transmitted video or metadata by the plurality of users. This allows I) the users in the same cluster to share their video or metadata, II) the users to generate a trend or video based on the generated clusters or III) for example the broadcaster to report or broadcast the event using the video or metadata.

The processor 12, transient memory 13, and non-transient memory 14 are electronics that enable the recording, storing, and saving of videos. The processor 12 is typically a microprocessor that provides instructions to the recording device 11 commanding it to start recording video, store video to the transient memory 13, save the video stored in the transient memory 13 to the non-transient memory 14, and any other functions that the recording device 11 is capable of. The transient memory 13 may be a circular buffer or a buffer that allows video to be temporality stored and be updated. The amount of temporary video to be stored may be a duration preset by the user in the recording device 11 or the software application 15. The duration may be several seconds or several minutes long. For example, when the recording device 11 is set to store 10 seconds of temporary video, the recording device 11 would initially store 10 seconds of video.

If the user does not select to record video after 10 seconds, the first second of video would be discarded by the buffer and the space freed in the buffer would be used to store the eleventh second of video. As such, the buffer is always being updated with the most recent video prior to the user selecting to record. The non-transient memory 14 may be a hard drive, digital versatile disc, compact disc, read-only memory, or other medium that retains its data after power is removed. The storage size of the transient memory 13 is preferably smaller than that of the non-transient memory 14. But other sizes are also contemplated by the present invention. The processor 12, transient memory 13, and non-transient memory 14 may be all housed in either the recording device 11 or the mobile device 16, or be separately housed between the recording device 11 and the mobile device 16. The transient memory 13 and non-transient memory 14 may also be placed at a location remote from the recording device 11 and the mobile device 16, such as at the server 19, in order to render the physical sizes of the recording device 11 and the mobile device 16 smaller and to allow instant sharing with other users of the recording devices 11 and the director at the server. The non-transient memory 14 can also be used as a form of transient memory 13 or be involved in the buffering such as storing a cache that holds some or all of the buffered video 20 in a circular or other type of buffer.

A database, which is based on information about the visual event or location is physically and logically stored on the server 19 and is configured to communicate with the server 19. With the correct visual event or location in the database, the captured and recorded images and the metadata are stored and saved in the database. As such the metadata, images and videos are kept in the database for viewing by the public, or broadcasting collected images and videos to third parties via their mobile devices, or conventional broadcast media, such as television, webcasts, or cable services. The images and videos can also be disseminated to service subscribers, posted on websites, or shared across social networks.

The software application 15 resident on the mobile device 16 serves, for example, as a bridge between user input and the recording device 11/the mobile device 16. The software application 15 may allow the user to initiate recording of the recording device 11 and to preset the duration of the video stored buffered video 20 by instructing the corresponding hardware in the recording device 11 and the mobile device 16. The software application 15 may also be used to generate metadata by the collaboration of the algorithms in the software application 15 and the hardware in the recording device 11 and the mobile device 16. The software application 15 may be further implemented to generate video assets for the user by compiling some or all of the recorded videos, the prior videos, the periodic recorded videos, and the metadata. The video assets may comprise video highlights of the day, a thumbnail video of the user's experiences throughout the day, a compilation of the metadata throughout the day, or a combination thereof. All the recorded videos, data, and assets may be automatically transmitted or be selectively chosen by the user to be transmitted over the wireless network 18 to the server 19 by the software application 15. In another embodiment, the video assets may be generated at the server 19 end, rather at the mobile device end, after the server 19 receives the recorded videos and metadata.

The wireless network 18 and the server 19 are included in the communication component 17 of the mobile recording and communication system 10. The wireless network 18 may be WiFi, Bluetooth, WPAN, WLAN, wireless mesh network, wireless MAN, wireless WAN, cellular network, or GAN. The wireless network 18 acts as a transmission medium between the recording device 11/the software application 15/the mobile device 16 and the server 19 and between each recording device 11 if there are multiple recording devices 11. The server 19 is configured to provide associated services such as identifying videos of the same event by different mobile device, metadata, and/or video assets based on the videos, metadata, and/or video assets received from multiple recording devices 11, forming a cluster for the intersecting videos, metadata, and/or video assets, and sharing the intersecting videos, metadata, and/or video assets among the users of the recording devices 11 in the formed cluster. Intersecting videos refer to videos that have a similar content such as but not limited to metadata, images or videos that are pointing in the same direction in order to create a formation of a cluster. The metadata may include but is not limited to the position of the user, direction of focus of the recording device 11 by the user, the speed of the recording device 11, and time and date of the recording.

In one embodiment, the server 19 may determine similar metadata from multiple recording devices 11 and form a cluster by grouping the recording devices associated to the determined similar metadata. The recording devices 11 or users in that cluster then can share their videos with each other and allow each other to watch the event from a different angle if his or her view was obstructed or to obtain a complete picture of the event. Moreover, the associated services may further comprise instantly and automatically generating a trend on social networking websites such as Twitter, Facebook, or a blog upon cluster formation. The trend may be a headline, page, or group that contains a brief description of a particular interesting moment in an event and the videos showing that particular interesting moment recorded by the recording devices 11 in that cluster. This allows the public to also access the recorded videos even if they are not at the scene utilizing the recording device 11. While the discussion above involves only one cluster, multiple clusters can also be formed if there are multiple interesting moments in the event. The multiple clusters can form simultaneously or at different times depending on when those multiple interesting moments occur. Multiple trends generated based on the multiple clusters may allow individuals not at the scene to experience watching the event from the locations of the recording devices 11 and to follow the event closely.

In one embodiment, the mobile recording and communication system 10 may be utilized real-time at a sporting event or a concert, an emergency situation or the like. A portion of the audience at the event may be given the recording devices 11 with each device worn by each spectator. The recording device 11 may be an eyewear apparatus such as a glass worn by the user with a camera, touchpad, and display. The camera is capable of recording video, which may be a single visual image, a series of visual images, or a combination of visual images and audio. The touchpad may allow the user to select, i.e., turn on, recording, to preset or subsequently adjust the duration of the buffered video 20 so as to pick which recorded or shared videos and metadata to view, to choose which recorded videos and metadata to transmit to the server 19 for sharing, or other functions that the glass may have. It is also possible to save the buffered video 20 to a non-transient memory 14 or a combination of transient 13 and non-transient 14 memory and then implement a process that rewrites the content of the video in a circular buffer type fashion. The touchpad may be used in conjunction with voice commands or be optional if the glass is configured to solely receive voice commands. The display may be any electronic visual display, but preferably a liquid crystal display as the glass is wearable by the user, capable of showing videos. Each spectator wearing the glass may sit at a different location and watch the event from a different angle.

When the spectator powers on the recording device 11, the recording device 11 is automatically and continuously storing a duration of video, i.e., 10 seconds, preset by the spectator to the transient memory 13 even if the spectator does not select to record video. The 10 seconds of video is constantly being updated with the latest 10 seconds of video prior to the moment the spectator selects to record since the transient memory 13 has a temporary storage characteristic as discussed above. When a moment interested to the spectator is about to occur, the spectator may select recording by pressing the touchpad which simultaneously saves the latest 10 seconds of video prior to pressing the touchpad to the non-transient memory 14. At this time, the recording device 11 starts recording the moment, and the feature of continuing to store 10 seconds of temporary or prior video is disabled. When the spectator stops recording by pressing the touchpad again, the spectator has both videos of what he or she recorded and a 10 second video prior to what he or she recorded. The spectator may also have periodic recordings, such as a video recorded every hour, if the recording device 11 is set to have that feature. The spectator may further have video assets at the end of the sporting event and/or at the end of the day, depending on the setting for the generation of video assets in the software application 15. The metadata for each recorded video and asset may also be generated and recorded. The recording also resumes the feature of continuing to store 10 seconds of temporary or prior video so that another 10 seconds of video immediately preceding the recorded video is available next time when the spectator selects to record again.

While the example illustrates a 10 second time period, a skilled artisan would recognize that the invention is operable over many different time periods ranging from seconds to tens of seconds to minutes to tens of minutes to even one or more hours. These periods are limited only by the memory storage and battery life of the recording device.

The recording device 11 may have the option to share or not to share the recorded videos, video assets, and metadata. When the spectator chooses to share, his or her recorded videos, video assets, and metadata may be shared with spectators who are also using the recording devices 11 or only with the spectators in the same cluster, i.e., those who have intersecting or similar videos, video asserts, and/or metadata. Shared videos, video assets, and metadata are the information that spectator picks to be transmitted or information that are automatically transmitted (if no restriction is set and the spectator wants everything to be shared) to the server 19 over the wireless network 18, making them available on the server 19 for other spectators to access via their recording devices 11 and the wireless network 18. Since these shared videos, video assets, and metadata are transmitted to the server 19, they are also available to the director at the server 19. The transmission to the server 19 allows the spectator's videos, video assets, and metadata to be permanently saved in the non-transient memory 14 when the non-transient memory 14 is located in the server 19.

In another embodiment, the spectators can also live stream each other's view without first transmitting his or her videos and metadata to the server 19 and, at the same time, transmitting those videos and metadata to the server 19 to be permanently saved. With this feature, a spectator can have multiple live views from other spectators at different angles. These multiple live views may be shown on the display of the glass in multiple windows or in one single window that can be toggled between different views by pressing the touchpad. The live view of one of the recording devices 11 may also be obtained by the other recording devices 11 by having a sufficient number of recording devices 11 focusing on that one recording device 11. This feature is particularly useful when the players in the sporting event are also wearing the recording devices 11 so that their live views can also be obtained. For example, all the players in the sporting event and a portion of the audience may be given the recording devices 11. When a player on the field performs a specific action catching the spectators' attention, a number of recording devices 11 or spectators would direct their views to that player. When the number of recording devices 11 directed to that player is greater than a number set in the system, the view of that player, produced by the recording device 11 he or she is wearing, is transmitted to and shared with other spectators. All the live views, whether they come from other spectators or players, can also be simultaneously saved on the server 19 while streaming.

If the spectator chooses not to share, the spectator's recorded videos, video assets, and metadata are available to himself or herself only and the spectator will not have access to other spectators' intersecting or similar videos, video assets, and metadata because his or her recorded videos, video assets, and metadata are not available for determining, whether his or her recorded videos, video assets, and metadata intersect or are similar to those of other spectators.

In addition, the server 19 may still be able to figure out whether a specific spectator is part of a cluster, which is based on the direction that the camera is specifically pointing towards and then share other users' videos (i.e., from those who chose to share video) with specific spectator.

Notwithstanding this, the spectator has the option to share later if the spectator subsequently changes his or her mind. Sharing later would update the pool on the server by adding the spectator's videos, video assets, and metadata. Sharing later may allow the determination of who have intersecting or similar videos, video assets, or metadata, and notify those who do and provide them immediate access to that spectator's sharing.

At the sporting event, another moment interested to the spectators may happen on a specific portion of the filed, perhaps where a significant or unusual play occurs, or even elsewhere in the sports arena where they are not focusing on the field. This moment may be the arrival of a celebrity or politician, a fight between fans in the stands, etc.

As such, some of the spectators may shift their attention away from the field to where that moment is occurring such as at a seating area or luxury suite. Thus, in addition to forming a cluster on the field based on the spectators focusing on the field, as they all have intersecting or similar videos or metadata, another cluster may be formed away from the field at the seating area or luxury suite based on the spectators shifted to that area or suite. Additional clusters may be formed as the event progresses if there are more such moments, and the spectators in each cluster may share and watch videos and metadata of other spectators in the same cluster or other clusters. Sharing with other clusters has the advantage of allowing the spectators in one cluster to know what is happening in another part of the sports arena without them looking at that direction, if the spectator is not aware or cannot locate the occurrence, or if the spectator's view from his or location is obstructed. This information may be provided by creating a window on their displays showing what is happening in another part of the sports arena by transmitting the videos and metadata from the other clusters. This information may be simultaneously provided as it is occurring or subsequently provided after its occurrence and saving on the server.

The server 19 configured for providing associated services and saving the videos, video assets, and metadata from some or all of the recording devices 11 may have a dashboard interface for the use by a director or operator. The dashboard interface may display the automatically generated clusters and trends, and their accompanied videos, to provide an immediate or current summary of the event. The dashboard interface may also display multiple summaries for multiple events if multiple sets of recording devices 11 are employed, with each set being used at each event. The dashboard interface may also make all the shared videos, video assets, and metadata that are saved on the server available for the director to access them. With these capabilities, the director can create a video of his choice or a video representative of the event. The representative video may be shared with all the record devices to provide a quick view of the event if the user only wants a summary. It may also be used for news reporting purpose.

The director may use the dashboard interface to broadcast live streaming by one or more recording devices 11 to viewers not at the event. This way, the embodiments of the present invention may be used to supplement additional videos or views that cannot be captured by on-field cameras or cameramen from broadcasting companies to provide a more comprehensive video of the event for those viewers. Broadcasting companies may also adopt this feature as their sole means for recording or broadcasting the event so that they do not send any cameraman to the scene. In that case, the director and server may be directly associated to the broadcasting company.

In preferred embodiments, the dashboard interface is software that is implemented on a computer such as a server or a computer that communicates with a server. The dashboard interface is preferably a dedicated resident or browser based application that interacts with the server, videos, or metadata and display on an associated display screen content that is received by the server and available to a director for generating video clips. Video can be in the form of conventional or proprietary video/audio formats such as MPEG and can include intermediary formats that may be used for streaming or communication.

The server 19 having communications components 17 over which the server 19 receives buffered 20 and recorded video and individually associated metadata from the users comprises a processor 12 and associated memory that is configured and adapted to process the metadata in order to identify trends from the cluster information in the metadata and to display the trends to a user of the computer system. The server 19 is further configured to allow the user of the system to select specific buffered 20 and recorded content associated with a particular trend of the visual event. As such, the server 19 can be configured to automatically combine an individual users buffered video 20 with the user's self-recorded video such as when the server 19 receives the distinct video content, and then automatically combines the two into a single video, a single video asset. This can be offered to users as an option to combine video on their recording devices 11 through their associated software application. It can then trigger the combination at the server 19 without user intervention. Alternatively, the merging can occur without the user or someone at the server 19 making an affirmative selection.

It is to be understood that the server 19 is geographically and remotely separated from the plurality of recording devices 11 of the users that are specifically directed to capture the visual event real-time as demonstrated in FIG. 1A. Servers 19 and other devices mentioned herein preferably have software and circuitry configured and adapted to provide a network interface that receives and transmits messages over one or more communications network. Video, metadata, or other communications related to the video capture and merge service is received and transmitted using the hardware and circuitry.

While the disclosure has been provided and illustrated in connection with specific embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases, the order of process steps may be varied without changing the purpose, effect, or import of the methods described. The scope of the embodiments of the invention is to be defined solely by the appended claims, giving due consideration to the doctrine of equivalents and related doctrines.

Further since numerous modifications and changes will readily be apparent to those having ordinary skill in the art, it is not desired to limit the invention to the exact constructions as demonstrated in this disclosure. Accordingly all suitable modifications and equivalents may be resorted to falling within the scope of the invention.

Unless defined otherwise, all technical and scientific terms used herein have same meaning as commonly understood by the person of ordinary skill in the art to which this invention belongs. As used herein and in the appended claims, the singular form “a”, “and”, and “the” include plural referents unless the context clearly dictates otherwise. All technical and scientific terms used herein have the same meaning. Thus the scope of the embodiments of the present invention should be determined by the appended claims and their legal equivalents rather than by the Figures.

What is claimed is:

1. A mobile recording and communication system comprising:
a recording device having circuitry that captures video;
a processor, a transient memory, and an non-transient memory;
a software application resident on a mobile device; and
a communication component comprising a server configured to provide associated services;
wherein the transient memory automatically and continuously stores video from the recording device with a duration set by a user of the recording device without the user selecting to record using the recording device, the video stored in the transient memory is permanently saved to the non-transient memory when the user selects to record using the recording device and is permanently saved as a video with the duration set by the user prior to the user selects to record,
wherein the recording device starts recording an event of interest when the user selects to record using the recording device and the recording devices produces a video of the event, and
wherein the software application is executed by the processor and is configured to transmit, over the wireless network, both the video with the duration set by the user prior to the user selects to record and the video of the event to the server configured for providing associated services.

2. The system of claim 1, wherein one of the recording device, the software application, and the mobile device generates metadata for the video with the duration set by the user prior to the user selects to record and metadata for the video of the event.

3. The system of claim 2, wherein the metadata comprises position of the user, direction of focus of the user, speed of the user, or time and date of the video with the duration set by the user prior to the user selects to record and the video of the event.

4. The system of claim 3, wherein one of the recording device, the software application, and the mobile device further generates video assets based on the video with the duration set by the user prior to the user selects to record, the video of the event, the metadata for the video with the duration set by the user prior to the user selects to record, and the metadata for the video of the event.

5. The system of claim 4, wherein the video assets comprise video highlights of a day, a thumbnail video of the user's experiences throughout a day, a compilation of all the metadata throughout a day, or a combination thereof.

6. The system of claim 1, further comprises multiple recording devices, and the associated services comprise determining intersecting videos or metadata based on the videos or metadata received from the recording device and the multiple recording devices, forming a cluster for the intersecting videos or metadata, and sharing all the intersecting video or metadata with the users in the formed cluster.

7. The system of claim 6, wherein sharing all the intersecting video or metadata further include sharing with users from a different cluster.

8. The system of claim 6, wherein sharing all the intersecting video or metadata further include sharing with a broadcasting company.

9. The system of claim 6, wherein forming a cluster for the intersecting videos or metadata instantly and automatically generates a trend on social networking websites.

10. The system of claim 9, wherein the trend is a headline, page, or group that contains a brief description of a particular interesting moment in the event and the videos showing the particular interesting moment recorded by the recording devices in the formed cluster.

11. The system of claim 6, wherein the server configured for providing associated services comprises a dashboard interface that is operable by a director and provides the director access the shared videos or metadata.

12. The system of claim 11, wherein the director creates a representative video of the event using the shared videos or metadata.

13. The system of claim 1, wherein the video is a single visual image, a series of visual images, or a combination of visual images and audio.

14. The system of claim 1, wherein the event of interest is a sporting event, a concert, an emergency situation, a spontaneous event that arises in everyday life, or any event in which the user has interest.

15. A computer implemented method of identifying a user's level of interest in an object at an event or location, which method comprises:
identifying a plurality of users at an event or location having active electronic devices capable of both capturing videos real-time and communicating metadata in the form of buffered and recorded video over the communication components;
transmitting the captured and recorded videos and metadata to a remote server;
compiling the transmitted videos and metadata generated by the electronic devices on the server;
forming a cluster for the intersecting videos or metadata, such that intersecting videos or metadata represent similar results submitted by a plurality of users focusing on the object at the event or location;
allowing the user of the system to select specific buffered and recorded content associated with a particular trend to combine into a video asset capturing a visual event associated with the trend; and
sharing all the intersecting videos or metadata with the plurality of users in the formed cluster.

16. The method of claim 15 further comprising a processor and associated memory that is configured to process the metadata to identify trends from cluster information in the metadata and configured to display the trends to a user of the system, and is further adapted to allow the user of the system to select specific buffered and recorded content associated with a particular trend to combine into a video asset capturing a visual event associated with the trend.

17. The method of claim 15, wherein sharing all the intersecting video or metadata further includes sharing with the plurality of users from a different cluster.

18. A mobile device comprising:
a recording device having circuitry that captures video communications circuitry that is configured to provide personal voice or data communications over a wireless network;
a processor, transient memory, and non-transient memory; and
a software application resident on the mobile device that is executed by the processor and is configured to automatically store video from the video recording component in a circular buffer in the transient memory without the user selecting to record video using the video recording component, wherein the software application transmits, over the wireless network, video from the buffer to a server configured for providing an associated service when the user selects to record video using the video recording component.

19. A system comprising:
a server that comprises network communication components over which the server receives buffered and recorded video from mobile devices and is configured to combine individual buffered video with recorded video from the same mobile device to form a single video asset for the user, and further wherein the server is configured to store the assets in a database and transmits the assets over a network.

20. A system comprising:
a server comprising communications components over which the server receives buffered and recorded video and individually associated meta data and comprises a processor and associated memory that is configured to process the metadata to identify trends from cluster information in the metadata and to display the trends to a user of the system and is further configured to allow the user of the system to select specific buffered and recorded content associated with a particular trend to combine into a video asset capturing a visual event associated with the trend.

21. A computer implemented method of identifying a user's level of interest in an object at an event or location, which method comprises:
automatically and continuously storing video from user's recording devices with a duration set by a user of the recording device without the user selecting to record using the recording device;
the stored video in non-transient memory of a server when the user selects to record using the recording device;
recording an event of interest when the user selects to record using the recording device and the recording devices produces a video of the event; and
transmitting over a wireless network to a server, both the video with the duration set by the user and the video of the event to the server wherein the server is configured for providing associated services for the event.
